(19) United States
(12) Patent Application Publication
(10) Pub. No.: US 2008/0165392 A1
(43) Pub. Date: Jul. 10, 2008

(54) Imaging Device, Printing System, Printing Device, Image Printing Method, And Recording Medium Storing Thereon A Control Program For The Image Printing Method

(76) Inventor: Naoto Yumiki, Osaka (JP)

Correspondence Address: MCDERMOTT WILL & EMERY LLP, 600 13TH STREET, NW, WASHINGTON, DC, 20005-3096, US

(21) Appl. No.: 11/883,365

(22) PCT Filed: Jan. 25, 2006
(86) PCT No.: PCT/JP2006/301132

§ 371 Date: Jul. 31, 2007

(30) Foreign Application Priority Data
Jan. 31, 2005 (JP) 2005-023842

(51) Int. Cl. H04N 1/04; H04N 1/21

(52) U.S. Cl. 358/474; 358/296

(57) ABSTRACT

An imaging device operable to print or display a synthesized image having fine visibility is provided. The imaging device includes an imaging optical system; an image sensor for converting an optical image to an electrical image signal; a posture detection section for detecting a posture of the imaging device, which is taken upon shooting; a recording section for recording a shot image based on the image signal and posture information pertinent to the posture of the imaging device and corresponding to the shot image; an adding section for adding character information, which corresponds to the shot image and contains character string; a printing control section for generating printing data containing the shot image and the character information; and a printing data output section for outputting the generated printing data. The printing control section, based on the posture information, generates printing data containing the shot image and the character information added by the adding section in a direction which is same as a direction of the shot image.

### RELATED APPLICATIONS

This application is the U.S. National Phase under 35 U.S.C. § 371 of International Application No. PCT/JP2006/301132, filed on Jan. 25, 2006, which in turn claims the benefit of Japanese Application No. 2005-023842, filed on Jan. 31, 2005, the disclosures of which applications are incorporated by reference herein.

### TECHNICAL FIELD

The present invention relates to a printing method of an image shot by an imaging device. More particularly, the present invention relates to an imaging device, a printing device and a printing system, which are operable to control an image printing method, and a recording medium storing thereon a control program for the image printing method.

### BACKGROUND ART

In recent years, the degree of integration in an image sensor, such as a CCD (Charge Coupled Device) and a CMOS (Complementary Metal-Oxide Semiconductor), and in a signal processing circuit is increasing. Further, the image sensor can be provided more inexpensively. As a result, a digital still camera and a digital video camera (hereinafter, simply referred to as a digital camera) which are capable of converting an optical image of an object to an electrical signal and outputting the signal have seen a rapid prevalence.

When an image shot by the digital camera is printed, the shot image is first loaded into a personal computer connected with the imaging device. And a printing device connected to the personal computer prints out the shot image on a print sheet in response to a printing instruction sent from the personal computer.

However, in operations in which the shot image is loaded into the personal computer and outputted to the printing device connected to the personal computer, a photographer or a person involved in the operations (hereinafter, referred to as a photographer or the like) is required to operate the personal computer. Accordingly, there accrues a problem that it is not easy for a photographer or the like, who is unfamiliar with the personal computer, to perform the operations. In addition, in order to perform the operations, software for loading the shot image into the personal computer and software for outputting the shot image onto the printing device are required to be installed on the personal computer.

On the contrary, a printing device which is capable of printing a shot image through directly connecting a digital camera and the printing device without using a personal computer has been proposed (patent document 1). The printing device allows a photographer or the like, who is unfamiliar with the personal computer, to easily print out the shot image. And in the printing device disclosed in the patent document 1, templates such as calendars and picture postcards have been previously stored in a recording section thereof, thereby making it possible to print out a synthesized image generated by arranging the shot image in a template.

On the other hand, a camera which is capable of recording, together with a shot image, additional information pertinent to shooting data such as a shooting date and time, a shutter speed, and an aperture has been proposed (patent document 2). The patent document 2 has proposed the camera which is capable of recording, as additional information, information pertinent to a location of shooting an image. The camera is equipped with a GPS (Global Positioning System) capable of locating a position on the ground by utilizing radio waves from artificial satellites. Positional information obtained by the GPS is recorded together with the shot image. Here, the positional information includes a character string indicating a latitude/longitude, a geographic name associated with the latitude/longitude, etc. Further, the camera disclosed in the patent document 2 is capable of displaying on a display section thereof an image having synthesized therein the shot image and the positional information.

Patent document 1: Japanese Laid-Open Patent Publication No. 10-107981
Patent document 2: Japanese Laid-Open Patent Publication No. 2000-196933

### DISCLOSURE OF THE INVENTION

### Problems to be Solved by the Invention

FIGS. 18A to 18C are diagrams showing a relationship between a posture of a digital camera and a posture of a shot image displayed on a display section. As shown in FIGS. 18A to 18C, a photographer conducts shooting while changing a posture of a digital camera 500 according to a purpose of shooting. For example, when a horizontally long object such as a landscape is to be shot, the photographer holds a posture of the digital camera 500 in a horizontal state, whereas when a vertically long object such as a portrait and a building is to be shot, the photographer holds a posture of the digital camera 500 in a vertical state. Hereinafter, a posture in which a stroke direction of a shutter button is in parallel with a direction of gravitational force, as shown in FIG. 18A, is referred to as a horizontal shooting posture of the digital camera 500, whereas a posture in which the stroke direction of the shutter button is perpendicular to the direction of gravitational force, as shown in FIG. 18B, is referred to as a vertical shooting posture of the digital camera 500. Images shot in the respective postures are referred to as a horizontally shot image and a vertically shot image, respectively. In the conventional digital camera 500, a shot image is recorded in the same posture as that of the digital camera 500 held upon shooting. In other words, if an image shot in the vertical shooting posture, as shown in FIG. 18B, is displayed on a display section of the digital camera 500 held in a horizontal posture as shown in FIG. 18C, a vertical direction of the shot image to be displayed is different from a vertical direction of the shot image upon shooting. Thus, since the shot image is recorded in the same posture as that of the digital camera held upon shooting, the conventional digital camera has the below-mentioned problem.

When a synthesized image of a shot image and a template is to be printed by using the printing device disclosed in the patent document 1, a photographer or the like is required to previously arrange the shot image so as to fit the template. For example, when an image shot in the vertical posture is arranged in a template which allows a horizontally shot image to be arranged therein, a photographer or the like is required to rotate the vertically shot image by 90 degrees and then arrange the vertically shot image on the template. Therefore, the photographer or the like is required to perform rotation processing in accordance with a shot image, leading to a problem of inferior usability.

In the camera disclosed in the patent document 2, a synthesized image of a shot image and positional information is generated. As shown in FIGS. 19A and 19B, however, when the synthesized image is printed, a character string 520 (hereinafter, a character string which is printed together with a shot image is referred to as “print characters”) containing the positional information is aligned in a predetermined direction and in a predetermined position of a shot image 510 irrespective of a shooting posture. Therefore, as shown in FIG. 19B, since directions of the shot image and the print characters, which are displayed on the display section, are different from each other, the photographer or the like has difficulties in seeing, thereby leading to a problem of inferior visibility.

Therefore, an object of the present invention are to provide an imaging device, a printing system, a printing device and a printing method, which realize comfortable display or print of an image having synthesized therein a shot image and printing characters, further a recording medium storing thereon a control program for the method.

### Solution to the Problems

The object of the present invention is attained by an imaging device having the following configuration. The imaging device is operable to output an optical image of an object as an electrical image signal and to transmit the image signal to a connected printing device. The imaging devise includes: an imaging optical system for forming the optical image of the object; an image sensor for receiving the optical image formed by the imaging optical system and converting the optical image to the electrical image signal; a posture detection section for detecting a posture of the imaging device, which is taken upon shooting; a recording section for recording a shot image represented by the image signal and posture information which corresponds to the shot image and indicates the posture of the imaging device; an adding section for adding character information, which corresponds to the shot image and contains a character string; a printing control section for generating printing data containing the shot image and the character information; and a printing data output section for outputting the generated printing data. The printing control section generates, based on the posture information, printing data containing the shot image and the character information which is added by the adding section so as to correspond to the direction of the shot image.

The object of the present invention is attained by a printing system having the following configuration. The printing system includes an imaging device and a printing device, which are connectable with each other. The imaging device includes: a recording section for recording a shot image and posture information, which corresponds to the shot image and indicates a posture of the imaging device; an adding section for adding character information, which corresponds to the shot image and contains a character string; a printing control section for generating printing data containing the shot image and the character information; and a printing data output section for outputting to the printing device the printing data generated by the printing control section. The printing device includes a printing section for printing the shot image and the character information based on the printing data outputted by the printing data output section. The printing control section generates, based on the posture information, printing data containing the shot image and the character information added by the adding section so as to correspond to the direction of the shot image.

In the above-mentioned configuration, print characters which are printed together with a shot image are arranged so as to correspond to the direction of the shot image. The synthesized image in which the direction of the print characters and the direction of the shot image match with each other, whereby a photographer or the like needs no operation of rotating the shot image or the print characters.

The object of the present invention is attained by a printing device having the following configuration. The printing device is operable to read out a shot image and posture information, corresponding to the shot image and being pertinent to a posture of an imaging device, which are stored in a recording section. The printing device includes: a requesting section for requesting from the imaging device the shot image and the posture information which have been stored in the recording section; an adding section for adding character information, which corresponds to the shot image obtained by the requesting section and contains a character string; a printing control section for generating printing data containing the shot image and the character information; and a printing section for printing the shot image and the character information based on the generated printing data. The printing control section, based on the posture information, generates printing data containing the shot image and the character information added by the adding section so as to correspond to the vertical direction of the shot image.

The object of the present invention is attained by a printing method having the following configuration. The image printing method is used for reading out a shot image and posture information, corresponding to the shot image and being pertinent to a posture of an imaging device, which are stored in a recording section and for printing the shot image. The image printing method includes: a reading-out step of reading out the shot image and the posture information; an adding step of adding character information, which corresponds to the shot image read out by the reading-out step and contains a character string; a printing control step for generating, based on the posture information, printing data containing the shot image and the character information added so as to correspond to the direction of the shot image; and a printing data output step of outputting the generated printed data.

### EFFECT OF THE INVENTION

As described above, according to the present invention, it is enabled to provide an imaging device, a printing system, a printing device, a printing method, which enable displaying or printing a synthesized image of print characters and a shot image in a comfortable manner, and a recording medium storing thereon a control program for the method.

### BRIEF DESCRIPTION OF THE DRAWINGS

FIG. 1 is a block diagram illustrating a control system of a digital camera according to an embodiment 1.

FIG. 2A is a diagram illustrating a top view of the digital camera according to the embodiment 1.

FIG. 2B is a diagram illustrating a rear view of the digital camera according to the embodiment 1.

FIG. 3 is a diagram illustrating a hardware configuration of an image blur compensation mechanism of the embodiment 1.

FIG. 4 is a diagram illustrating an exploded perspective view of the image blur compensation mechanism of the embodiment 1.

FIG. 5A is a diagram illustrating a posture of the image blur compensation mechanism of the embodiment 1.

FIG. 5B is a diagram illustrating a posture of the image blur compensation mechanism of the embodiment 1.

FIG. 6 is a diagram showing current amounts supplied to coils when respective shooting postures are taken in the embodiment 1.

FIG. 7 is a diagram showing posture determination signals for the respective shooting postures in the embodiment 1.

FIG. 8A is a diagram illustrating a rear view of the digital camera, on which an image shot in a horizontal shooting posture is displayed in the embodiment 1.

FIG. 8B is a diagram illustrating a rear view of the digital camera, on which an image shot in a vertical shooting posture is displayed in the embodiment 1.

FIG. 9 is a diagram illustrating only a main part of a control block diagram of the digital camera according to the embodiment 1.

FIG. 10 is a diagram showing connection of the digital camera and a printing device according to the embodiment 1.

FIG. 11 is a diagram showing a flowchart of printing processing of a shot image in the embodiment 1.

FIG. 12 is a diagram illustrating a thumbnail display example in the embodiment 1.

FIG. 13A is a diagram illustrating an example of a printing menu screen in the embodiment 1.

FIG. 13B is a diagram illustrating an example of a printing menu screen in the embodiment 1.

FIG. 14 is a diagram showing a flowchart of printing processing of a shot image in the embodiment 1.

FIG. 15A is a diagram illustrating an example of a synthesized image printed by the printing device of the embodiment 1.

FIG. 15B is a diagram illustrating an example of a synthesized image printed by the printing device of the embodiment 1.

FIG. 16 is a block diagram illustrating a control system of a digital camera according to an embodiment 2.

FIG. 17A is a diagram illustrating an example of a synthesized image printed by the printing device of the embodiment 2.

FIG. 17B is a diagram illustrating an example of a synthesized image printed by the printing device of the embodiment 2.

FIG. 18A is a diagram showing a relationship between a posture of the digital camera and a posture of a shot image displayed on a display section.

FIG. 18B is a diagram showing a relationship between a posture of the digital camera and a posture of a shot image displayed on a display section.

FIG. 18C is a diagram showing a relationship between a posture of the digital camera and a posture of a shot image displayed on a display section.

FIG. 19A is a diagram illustrating a synthesized image which is generated from a shot image and print characters, which is produced by a conventional digital camera.

FIG. 19B is a diagram illustrating a synthesized image which is generated from a shot image and print characters by the conventional digital camera.

### DESCRIPTION OF THE REFERENCE CHARACTERS

1 digital camera

1a housing

2 lens

3 microcomputer

3A signal processing section

4 image sensor

5 CCD drive control section

6 analog signal processing section

7 A/D conversion section

8 digital signal processing section

9 buffer memory

10 image compression section

11 image recording control section

12 image recording section

13 image display control section

14A shooting posture detection section

14x yawing current value detection section

14y pitching current value detection section

15A movement compensation section

15x yawing drive control section

15y pitching drive control section

16 position detection section

17A movement detection section

17x angular velocity sensor

17y angular velocity sensor

18x A/D conversion section

18y A/D conversion section

19x D/A conversion section

19y D/A conversion section

20 image blur compensation mechanism

21 pitching holding frame

22 yawing holding frame

23 pitching shaft

24 coil

25 fixing frame

26 yawing shaft

27 magnet

28 yoke

29 actuator

30 light emitting device

31 photodetector

35 power switch

36 shutter operation section

37 shooting/playback switching operation section

38 cross operation key

39 MENU setting operation key

40 SET operation key

41 shutter control section

42 shutter drive motor

45 GPS control section

46 GPS module

50 internal memory

51 removable memory

55 display section

57 zoom operation section

58 selected-image display section

59 pull-down menu for selecting the number of printed sheets

60 pull-down menu for selecting print characters

61 character input screen selection icon

62 printing execution icon

63 cancellation icon

64 printed sheet

65 print characters

66 printed sheet

67 print characters

70 posture determination signal

71 image printing control section

72 printing data output section

73 USB cable

74 printing device

80 print character memory

81 geographic name data memory

200 digital camera

### BEST MODE FOR CARRYING OUT THE INVENTION

### Embodiment 1

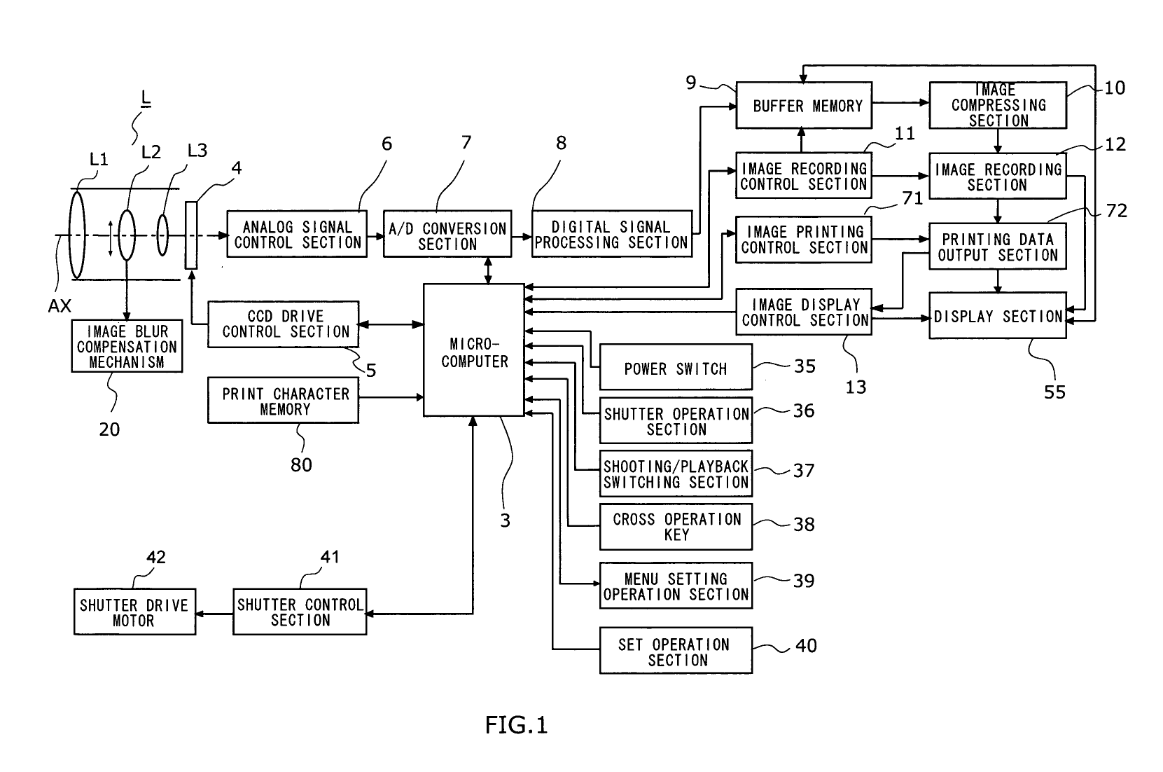

FIG. 1 is a schematic block diagram illustrating a configuration of a digital camera 1 according to an embodiment 1 of the present invention. The digital camera 1 includes, among others, an imaging optical system L, a microcomputer 3, an image sensor 4, a CCD drive control section 5, an analog signal processing section 6, an A/D conversion section 7, a digital signal processing section 8, a buffer memory 9, an image compression section 10, an image recording control section 11, an image recording section 12, an image display control section 13, a display section 55, a shutter control section 41, a shutter drive motor 42, an image printing control section 71, a printing data output section 72, and a print character memory 80.

The imaging optical system L is an optical system including three lens units L1, L2, and L3. The first lens unit L1 and the second lens unit L2 perform zooming by moving in an optical axis direction and the third lens unit L3 performs focusing by moving in the optical axis direction. And the second lens unit L2 functions as a compensation lens unit, compensating movement of an image by moving within a plane perpendicular to an optical axis so as to decenter the optical axis. A configuration of the imaging optical system L is not limited to the above-mentioned configuration of the optical system.

When mechanical vibration or jiggling which is caused by a photographer or the like is applied to the digital camera 1, an optical axis of light reflected from an object to a lens deviates from an optical axis of the lens. Accordingly, a blurred image is obtained. A mechanism for preventing the blurred image is hereinafter referred to as an image blur compensation mechanism. Further, in the present invention, the image blur compensation mechanism 20 can be used also as means for detecting a posture of the digital camera 1. A structure and operations thereof will be described hereinafter.

The microcomputer 3 controls the entire digital camera 1. The microcomputer 3 is capable of receiving signals from a power switch 35, a shutter operation section 36, a shooting/playback switching operation section 37, a cross operation key 38, a MENU setting operation key 39, and a SET operation section 40.

When the shutter operation section 36 is operated by a photographer, a timing signal is outputted. The shutter control section 41 drives the shutter drive motor 42 to operate a shutter in accordance with a control signal outputted from the microcomputer 3 which has received the timing signal.

The image sensor 4 is a CCD and converts an optical image formed by the imaging optical system L to an electrical signal. The image sensor 4 is controlled by the CCD drive control section 5. The image sensor 4 may be a CMOS.

The image signal outputted from the image sensor 4 is transferred to the analog signal processing section 6, the A/D conversion section 7, the digital signal processing section 8, the buffer memory 9, and the image compression section 10 in a sequential manner while being processed therein. The analog signal processing section 6 subjects the image signal outputted from the image sensor 4 to analog signal processing such as gamma processing. The A/D conversion section 7 converts the analog signal outputted from the analog signal processing section 6 to a digital signal. The digital signal processing section 8 subjects the image signal, which has been converted to the digital signal by the A/D conversion section 7, to digital signal processing such as noise removal and edge enhancement. The buffer memory 9 is a RAM (Random Access Memory) and temporarily stores the image signal processed by the digital signal processing section 8.

Further, the image signal stored in the buffer memory 9 is transferred from the image compression section 10 to the image recording section 12 in a sequential manner while being processed. The image signal stored in the buffer memory 9 is read out in response to an instruction from the image recording control section 11 and transmitted to the image compression section 10. Data of the image signal transmitted to the image compression section 10 is compressed at a predetermined ratio and reduced in size thereof. As a compression method, for example, a JPEG (Joint Photographic Experts Group) method is employed. Thereafter, the compressed image signal is transmitted to the image recording section 12.

The image recording section 12 is, for example, an internal memory and/or a detachable removable memory. Based on an instruction from the image recording control section 11, the image recording section 12 records the image signal and predetermined information, which are associated with each other. Here, an image file contains a data section in which the image signal is stored and a header or a footer section in which predetermined information is stored. The predetermined information, which is to be stored together with the image signal, includes a date and time at which an image is shot, focal length information, shutter speed information, aperture information, and shooting mode information. For example, an Exif (registered trademark) format or a format similar to the Exif (registered trademark) format is used.

The image display control section 13 is controlled by a control signal from the microcomputer 3. In response to an instruction from the image display control section 13, the image signal stored in the image recording section 12 or the buffer memory 9 is displayed on the display section 55 as a visible image. As a form of display on the display section 55, there are a form in which only a shot image represented by an image signal is displayed, and a form in which a shot image represented by the image signal and information upon shooting are displayed. The information upon shooting includes, for example, focal length information, shutter speed information, aperture information, shooting mode information, and focusing state information. These pieces of information are displayed through an operation of the MENU setting operation key 39.

The image printing control section 71 is controlled by a control signal from the microcomputer 3 and generates printing data which an external printing device 74 uses to print the shot image. Based on an instruction from the image printing control section 71, the printing data output section 72 outputs the image file containing the image signal stored in the image recording section 12 or the buffer memory 9 via a USB (Universal Serial Bus) cable 73 to a recording section of the printing device 74. A method for printing the shot image will be described hereinafter.

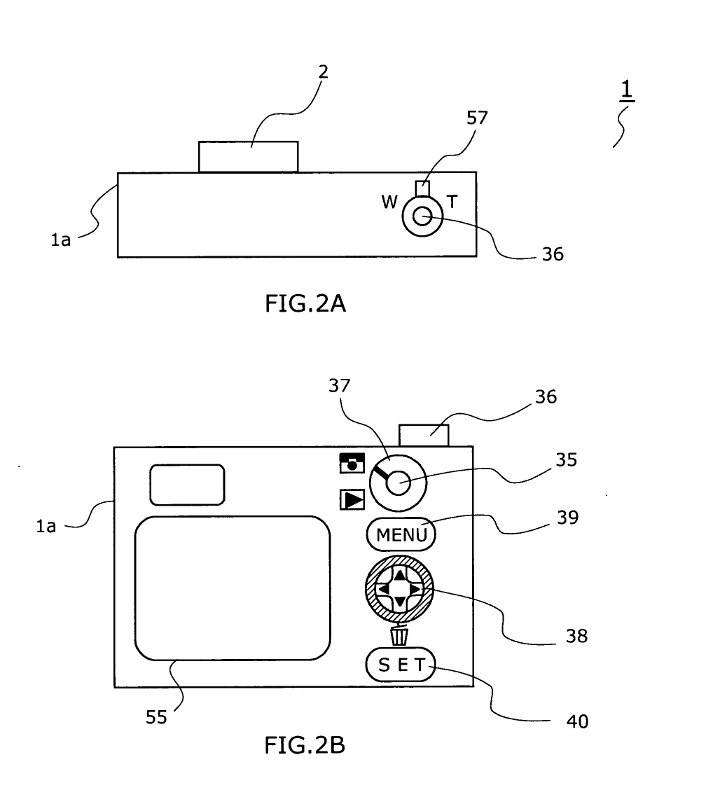

Next, a configuration of the digital camera 1 according to the embodiment 1 will be described with reference to FIGS. 2A and 2B. FIG. 2A is a diagram illustrating a top view of the digital camera 1 and FIG. 2B is a diagram illustrating a rear view of the digital camera 1.

A housing 1a includes an imaging optical system having a lens 2 on a front face thereof; and the power switch 35, the shooting/playback switching operation section 37, the cross operation key 38, the MENU setting operation key 39, the SET operation section 40, and the display section 55 which is an LCD monitor on a rear face thereof. The housing 1a further includes the shutter operation section 36 and the zoom operation section 57 on an upper face thereof.

The zoom operation section 57 is provided surrounding the shutter operation section 36 so as to be rotatable around the axis of the shutter operation section 36. The power switch 35 is an operation member for turning on/off power of the digital camera 1. The shooting/playback switching operation section 37 is an operation member for switching between a shooting mode and a playback mode by rotating a lever thereof. In a state where the digital camera 1a is switched to the shooting mode, the imaging optical system L is switched so as to be telephoto when the zoom operation section 57 is rotated clockwise and to be wide-angle when the zoom operation section 57 is rotated counterclockwise.

The MENU setting operation key 39 is an operation member for displaying various menus on the display section 55. The cross operation key 38 is an operation member for making selection from various operation menus, displayed on the display section 55 in response to an operation of the MENU setting operation key 39, by pressing upper, lower, right, and left portions thereof. The SET operation section 40 is an operation member for returning a display of the various operation menus to a previous state.

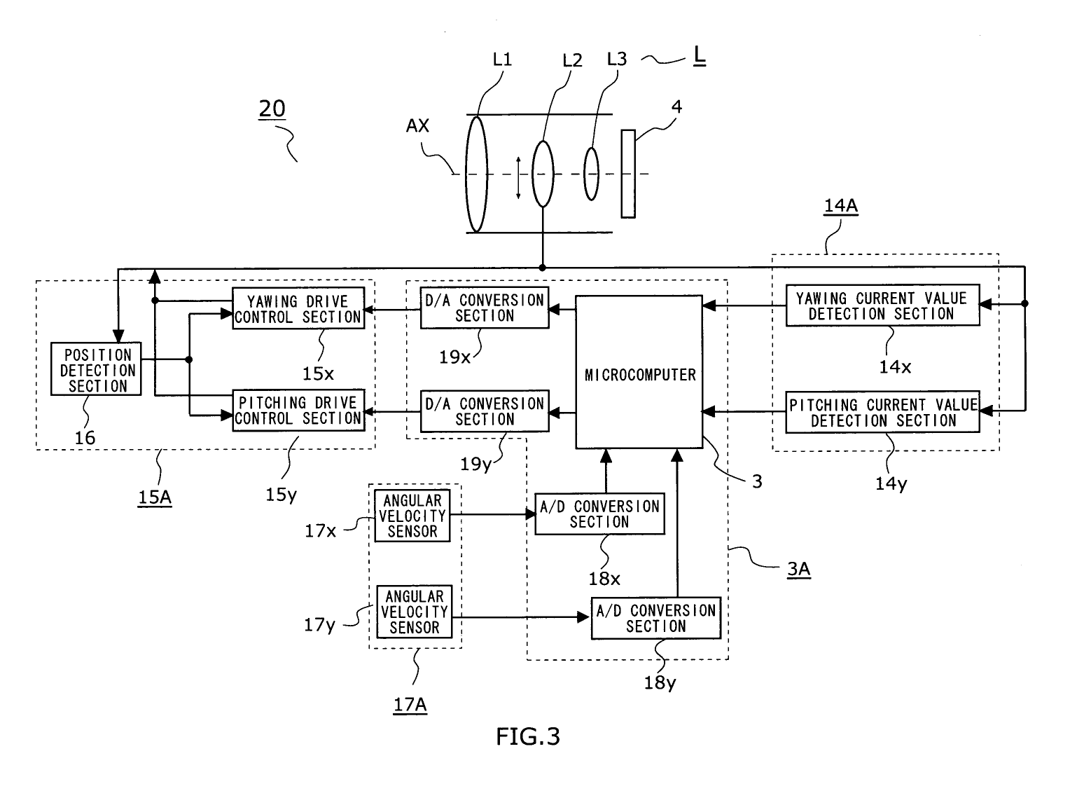

Next, a control system of the image blur compensation mechanism will be described with reference to FIG. 3. In FIG. 3, the image blur compensation mechanism 20 includes a movement compensation section 15A, a shooting posture detection section 14A, a movement detection section 17A, and a signal processing section 3A. The movement compensation section 15A for controlling an optical axis of imaging light includes the second lens unit L2, the yawing drive control section 15x, the pitching drive control section 15y, and the position detection section 16. And the second lens unit L2 functions as a compensation lens unit, compensating movement of an image by moving within a plane perpendicular to an optical axis so as to decenter the optical axis. The second lens unit L2 is controlled in two directions X and Y perpendicular to an optical axis AX by the yawing drive control section 15x and the pitching drive control section 15y. Hereinafter, the X direction and the Y direction are referred to as a yawing direction and a pitching direction, respectively. The position detection section 16 is detection means for detecting a position of the second lens unit L2 and forms a feedback control loop for controlling the second lens unit L2 together with the yawing drive control section 15x and the pitching drive control section 15y.

The shooting posture detection section 14A includes a yawing current value detection section 14x and a pitching current value detection section 14y. The yawing current value detection section 14x detects a value of a current flowing in a coil when a yawing actuator 29x operates. Similarly, the pitching current value detection section 14y detects a value of a current flowing in a coil when a pitching actuator 29y operates.

The movement detection section 17A includes a yawing angular velocity sensor 17x and a pitching angular velocity sensor 17y. The angular velocity sensors 17x and 17y detect movement of the imaging device in itself including the imaging optical system L, which is caused by hand jiggling and other vibration, detecting the movement in two directions of yawing and pitching, respectively. Each of the angular velocity sensors 17x and 17y outputs an angular speed signal of a positive or negative value corresponding to a direction in which the digital camera 1 moves, with reference to an output in a state where the digital camera 1 remains stationary. The outputted signal is processed by the signal processing section.

The signal processing section 3A includes the microcomputer 3, A/D conversion sections 18x and 18y, and D/A conversion sections 19x and 19y. Signals outputted by the angular velocity sensors 17x and 17y are subjected to filtering processing, amplifying processing and the like, thereafter converted to digital signals by the A/D conversion section 18x and 18y, and sent to the microcomputer 3. The microcomputer 3 subjects the output signals from the angular velocity sensors 17x and 17y, which have been obtained via the A/D conversion sections 18x and 18y, to filtering, integrating processing, phase compensation, gain adjustment, clipping processing and the like. By subjecting the signals to the above-mentioned processes, the microcomputer 3 calculates drive control amounts of the compensation lens unit L2, which are required for movement compensation and generates control signals. The generated control signals are outputted via the D/A conversion sections 19x and 19y to the yawing drive control section 15x and the pitching drive control section 15y. Based on the control signal, the yawing drive control section 15x and the pitching drive control section 15y drive the compensation lens unit L2 and compensate movement of an image.

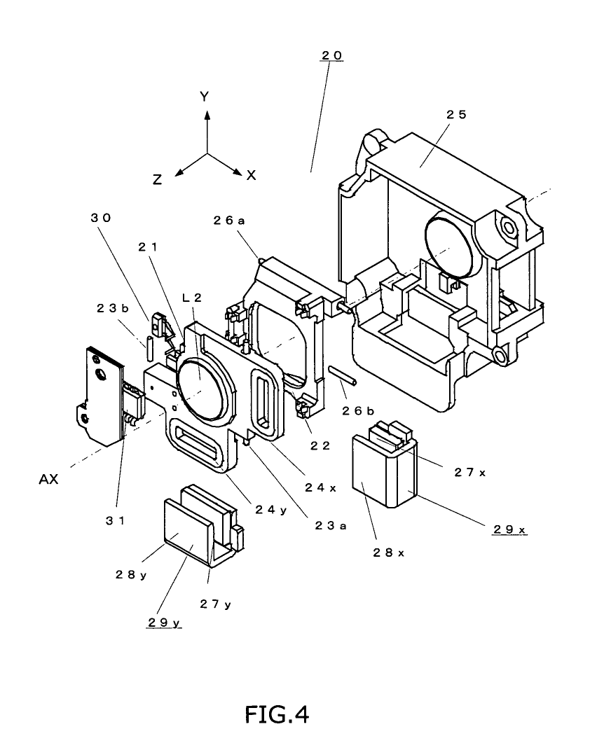

Next, a configuration of the image blur compensation mechanism 20 used in the present embodiment will be described with reference to FIG. 4. In FIG. 4, the image blur compensation mechanism 20 includes a pitching holding frame 21, a yawing holding frame 22, a fixing frame 25, a yawing actuator 29x, a pitching actuator 29y, a light emitting device 30, and a photodetector 31.

The pitching holding frame 21 has coils 24x and 24y. The second lens unit L2 and the light emitting device 30 are fixed on the pitching holding frame 21. The pitching holding frame 21 is coupled to the yawing holding frame 22 via two pitching shafts 23a and 23b so as to be slidable in the Y direction.

The yawing holding frame 22 is coupled to the fixing frame 25 via yawing shafts 26a and 26b so as to be slidable in the X direction.

A yawing actuator 29x has a magnet 27x and a yoke 28x and is coupled to the fixing frame 25. Similarly, the pitching actuator 29y has a magnet 27y and a yoke 28y and is coupled to the fixing frame 25.

The photodetector 31, which is fixed on the fixing frame 25, receives light emitted from the light emitting device 30 and detects two-dimensional position coordinates.

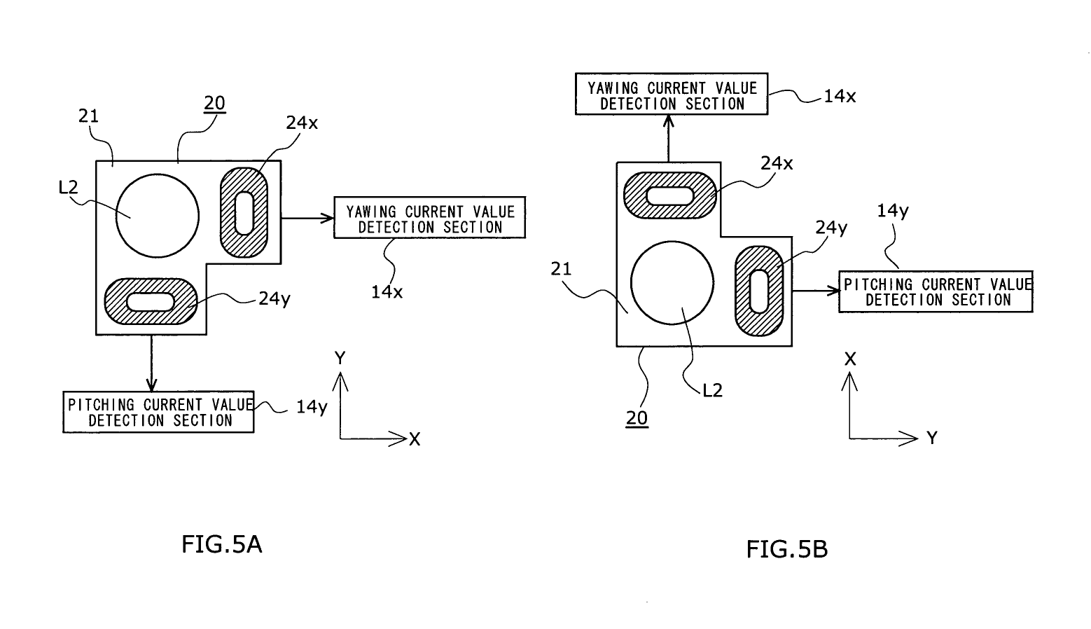

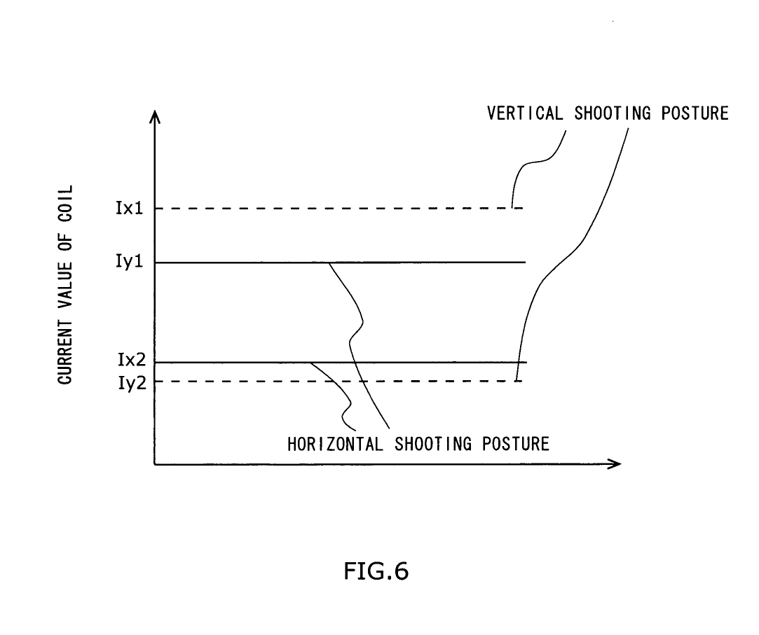

Next, a current value detection method using a yawing current value detection section 14x and a pitching current value detection section 14y will be described with reference to FIGS. 5A, 5B, and 6. FIGS. 5A and 5B show postures of the image blur compensation mechanism 20. FIG. 5A illustrates a posture of the image blur compensation mechanism 20 upon shooting in the horizontal shooting posture. FIG. 5B illustrates a posture of the image blur compensation mechanism 20 upon shooting in the vertical shooting posture.

In FIG. 5A, in a case of the horizontal shooting posture, weights of the second lens unit L2, the pitching holding frame 21, the coils 24x and 24y, and the yawing holding frame 22 act in the Y direction which is a direction of gravitational force. In this case, the second lens unit L2 is required to be supported toward the optical axis in order to obtain a desired image. Therefore, generation of electromagnetic power for supporting the weight of the second lens unit L2 is required. Accordingly, in order to generate the required electromagnetic power, a current of a value Iy1 is supplied to the coil 24y. On the other hand, as for the X direction, since the weight of the second lens unit L2 to be supported toward the optical axis is not required to be taken into consideration, a value Ix2 of the current supplied to the coil 24x is small as compared with the value Iy1 of the current supplied to the coil 24y.

FIG. 5B is a diagram illustrating a posture of the image blur compensation mechanism 20, which is the vertical shooting posture obtained when the horizontal shooting posture is rotated by 90 degrees around the optical axis. Weights of the second lens unit L2, the pitching holding frame 21, coils 24x and 24y, and the yawing holding frame 22 act in the X direction which is a direction of gravitational force. In this case, the second lens unit L2 is required to be supported toward the optical axis. Therefore, generation of electromagnetic power for supporting an weight of the yawing holding frame 22 in addition to the weight of the second lens unit L2 is required. Accordingly, in order to generate the required electromagnetic power, a current of a value Ix1 is supplied to the coil 24x. When the weight of the yawing holding frame 22 is taken into consideration, the value Ix1 of the current is large as compared with the value Iy1 of the current supplied to the coil 24y. On the other hand, as for the Y direction, since the weight of the second lens unit L2 to be supported toward the optical axis is not required to be taken into consideration, a value Iy2 of the current supplied to the coil 24y is small as compared with the value Ix1 of the current supplied to the coil 24x.

As described above, the values of the currents flowing into the coils 24x and 24y are determined depending on the shooting postures of the digital camera 1. In other words, the shooting postures of the image blur compensation mechanism 20 and the digital camera 1 are determined by detecting the values of the currents flowing in the coils. Accordingly, the image blur compensation mechanism 20 can be concurrently used for preventing an image blur and for serving as means for detecting the posture of the digital camera 1.

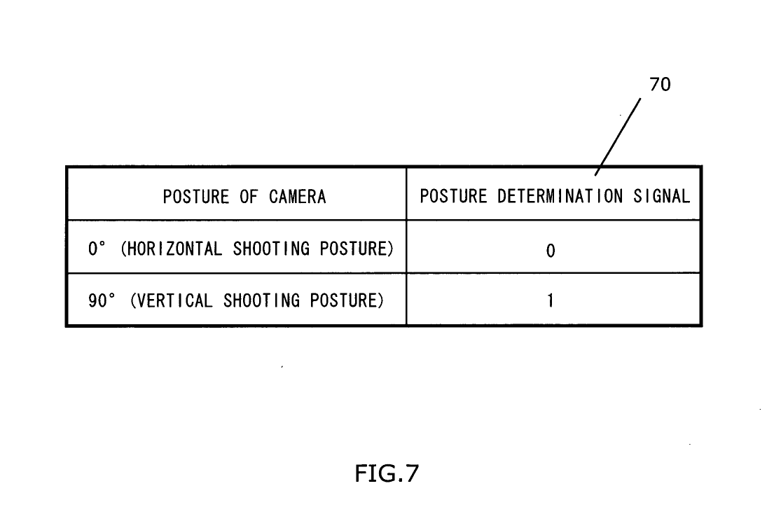

Next, operations of the digital camera 1 according to the present embodiment will be described with reference to FIGS. 1 to 9. FIG. 6 is a diagram showing current amounts supplied to the coils when the respective shooting postures are taken. FIG. 7 is a diagram showing posture determination signals for the respective shooting postures. When a photographer conducts shooting, the photographer first turns on the power switch 35 and thereafter, switches the shooting/playback switching operation section 37 to a shooting mode. Thus, the digital camera 1 shifts to a shooting state. After shifting to the shooting state, hand jiggling and vibration applied to the digital camera 1 are detected by the angular velocity sensors 17x and 17y. The microcomputer 3 gives to the yawing drive control section 15x and the pitching drive control section 15y instruction signals for canceling the caused hand jiggling or the like. In response to the instruction signals, currents are supplied to the respective coils 24x and 24y of the pitching holding frame 21. The pitching holding frame 21 is moved by a magnetic circuit, which is formed by the supplied currents and the magnets 27x and 27y, in two directions within an X-Y plane perpendicular to the optical axis AX. Position of the pitching holding frame 21 is detected with high precision through utilizing the photodetector 31. In other words, the second lens unit L2 is moved by the image blur compensation mechanism 20 within the plane perpendicular to the optical axis. Thus, the photographer can perform compensation of an image which enters the image sensor 4 via the imaging optical system L, thereby making it possible to shoot a fine image in which an image blur is suppressed.

In addition, a shooting posture of the digital camera 1 is determined as described below. Here, a posture of the digital camera 1 in the horizontal shooting posture is used as reference with an angle being 0 degree. A posture of the digital camera 1 in the vertical shooting posture is in a state where the digital camera 1 in the horizontal shooting posture is rotated by 90 degrees around the optical axis.

A case where a photographer shoots, in the horizontal shooting posture, a horizontally long object such as a landscape will be described. A posture of the digital camera 1 is determined by values of currents, which are detected by the yawing current value detection section 14x and the pitching current value detection section 14y. In FIG. 6, in a case of shooting in the horizontal shooting posture, i.e., the posture at an angle of 0 degree, a value Ix2 of a current flowing into the coil 24x of the image blur compensation mechanism 20 and a value Iy1 of a current flowing into the coil 24y of the image blur compensation mechanism 20 are detected by the yawing current value detection section 14x and the pitching current value detection section 14y, respectively. The microcomputer 3 can determine using these current values that the digital camera 1 is in the horizontal shooting posture. In this state, the photographer can shoot the object by pressing the shutter operation section 36. The shot image is recorded in the image recording section 12. Thereupon, as shown in FIG. 7, the image recording control section 11 adds, to an image signal outputted from the buffer memory 9, a posture determination signal 70(0) indicating that a posture of the digital camera 1 is at an angle of 0 degree. The posture determination signal 70 is recorded in, for example, a header or footer section of the image signal. The recording of the posture determination signal 70 may be performed in either the buffer memory 9 or the image recording section 12.

On the other hand, in a case where a photographer shoots a vertically long object such as a portrait, similarly to the case where shooting is performed in the horizontal shooting posture, a posture of the digital camera 1 is determined by values of currents, which are detected by the yawing current value detection section 14x and the pitching current value detection section 14y. In FIG. 6, in a case of shooting in the vertical shooting posture, i.e., the posture at an angle of 90 degrees, a value Ix1 of a current flowing into the coil 24x of the image blur compensation mechanism 20 and a value Iy2 of a current flowing into the coil 24y of the image blur compensation mechanism 20 are detected by the yawing current value detection section 14x and the pitching current value detection section 14y, respectively. The microcomputer 3 can determine using these current values that the digital camera 1 is in the vertical shooting posture. In this state, the photographer can shoot the object by pressing the shutter operation section 36. The shot image is recorded in the image recording section 12. Thereupon, the image recording control section 11 adds, to an image signal outputted from the buffer memory 9, a posture determination signal 70(1) indicating that the digital camera 1 is in the vertical shooting posture obtained when the digital camera 1 is rotated by 90 degrees with respect to the optical axis.

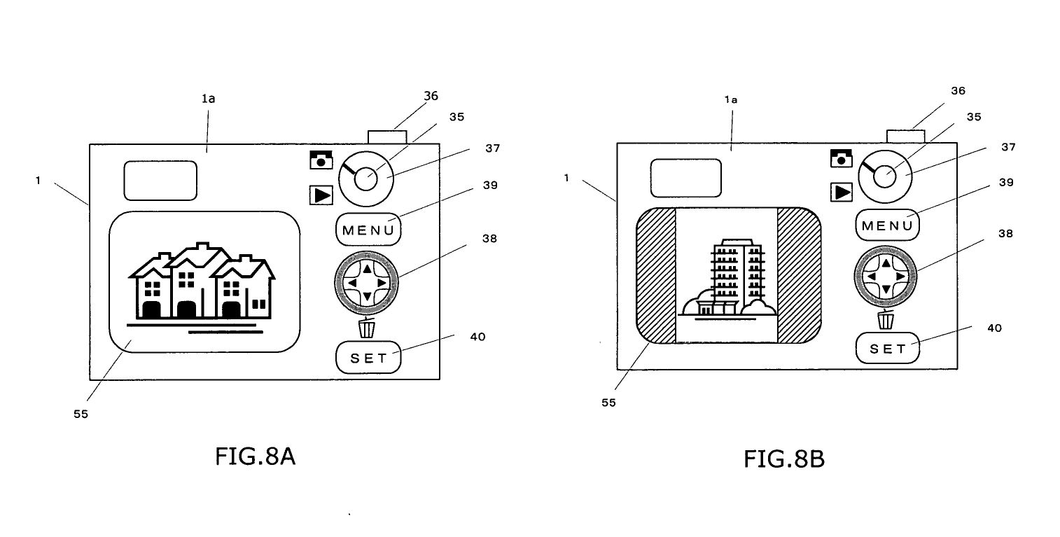

Next, display processing for displaying a shot image on the display section 55 will be described. FIG. 8A is a diagram illustrating a rear view of the digital camera 1, in which an image shot in the horizontal shooting posture is displayed. FIG. 8B is a diagram illustrating a rear view of the digital camera 1, in which an image shot in the vertical shooting posture is displayed. In order to display a shot image on the display section 55, a photographer first turns on the power switch 35 and thereafter, switches the shooting/playback switching operation section 37 to a playback mode. When the photographer selects an image from thumbnail images by operating the cross operation key 38, one frame of the shot image is displayed on the display section 55. Thereupon, the image display control section 13 performs display control based on the posture determination signal 70 which has been recorded together with the shot image.

The posture determination signal 70 (0) is added, upon shooting, to an image shot in the horizontal shooting posture. Accordingly, as shown in FIG. 8A, the image display control section 13 restores a posture of the shot image displayed on the display section 55 to the same posture taken upon shooting and performs displaying.

On the other hand, the posture determination signal 70 (1) is added, upon shooting, to an image shot in the vertical shooting posture. Accordingly, as shown in FIG. 8B, the image display control section 13 restores a posture of the shot image displayed on the display section 55 to the same posture taken upon shooting by rotating the posture of the shot image by 90 degrees and performs displaying.

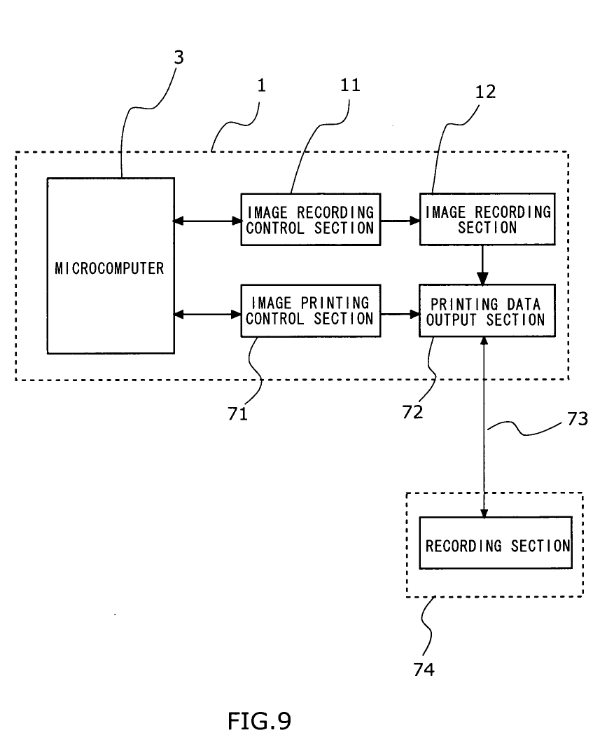

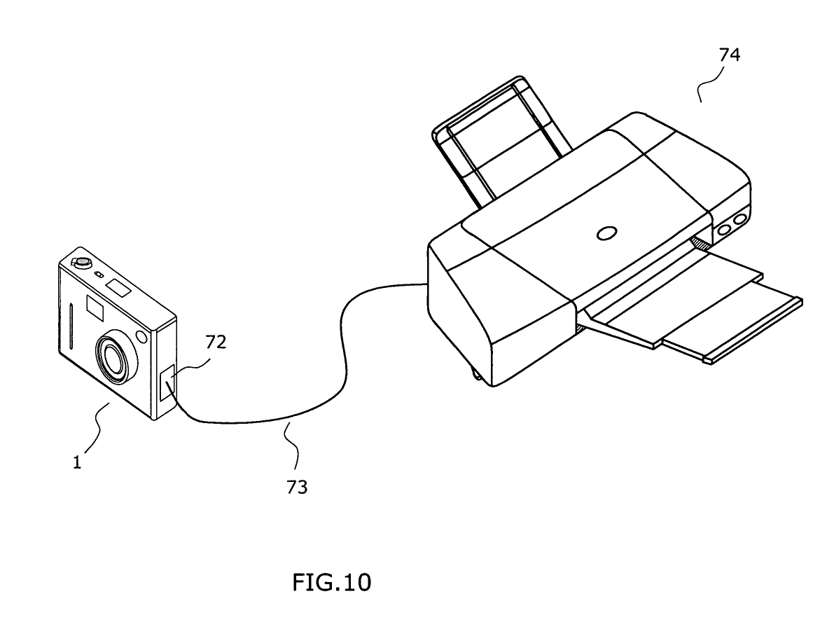

Next, printing processing of a shot image will be described with reference to FIGS. 9 and 10. FIG. 9 is a diagram illustrating only a main part of the control block diagram of the digital camera 1 shown in FIG. 1. The digital camera 1 and the printing device 74 are connected using the USB (Universal Serial Bus) cable 73. When the microcomputer 3 determines that printing execution is selected from a printing menu, the microcomputer 3 sends a printing instruction to the printing device 74. The image printing control section 71 is controlled in accordance with a control signal from the microcomputer 3 and generates printing data pertinent to the below-described synthesized image of an shot image and print characters. Based on an instruction from the image printing control section 71, the printing data output section 72 outputs the printing data and the image file, which is stored in the image recording section 12, via the USB cable 73 to the recording section of the printing device 74. The printing device 74, based on the transmitted printing data and the printing instruction, prints out the synthesized image of the shot image and the printing characters on a sheet.

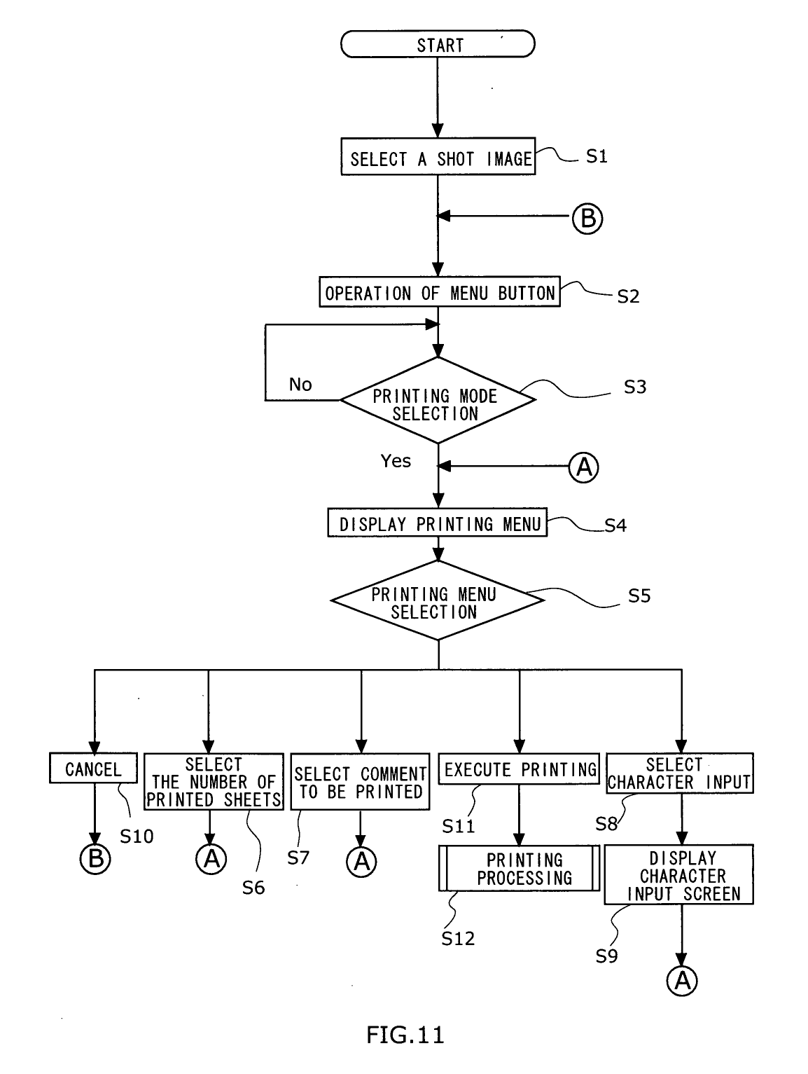

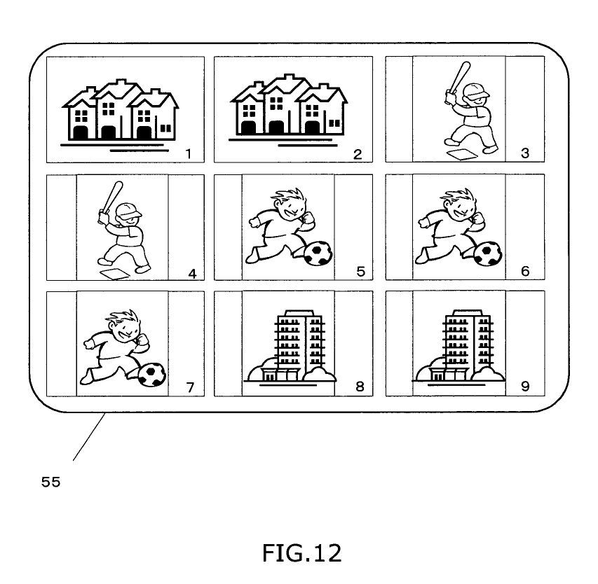

FIG. 11 is a diagram showing a flowchart of the printing processing of a shot image. After the microcomputer 3 determines that the shooting/playback switching operation section 37 is switched to the playback mode and that a shot image is selected by the cross operation key 38, the microcomputer 3 causes the digital camera 1 to proceed to the next step (Step 1). As for the selection of an image, as shown in FIG. 12, a shot image may be selected from thumbnail images, which are reduced in size, displayed on the display section 55. After selecting the shot image, the microcomputer 3 determines that the MENU setting operation key 39 is pressed and displays a menu screen on the display section 55 (Step 2). In the menu screen, a plurality of processing items such as printing mode selection and shooting mode selection are included. When the microcomputer 3 determines that the printing mode is selected from the menu display, the microcomputer 3 causes the digital camera 1 to proceed to the next step in order to perform the printing processing. On the other hand, when the printing mode is not selected, the menu screen or menus pertinent to various processing items are displayed on the display section 55 (Step 3).

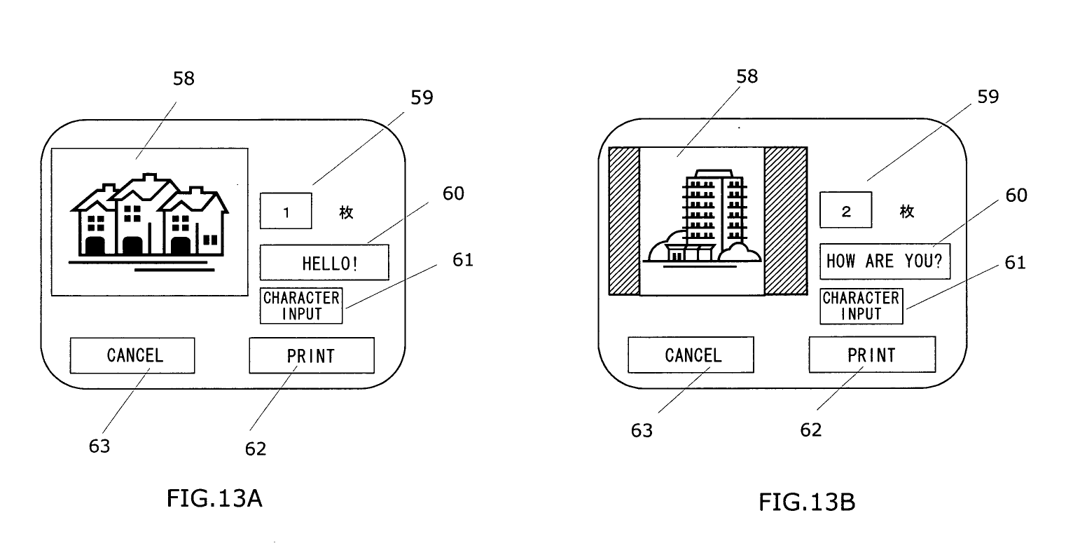

After the printing mode is selected, the microcomputer 3 causes the display section 55 to display a printing menu screen in which the number of sheets to be printed and print characters can be set (Step 4). FIGS. 13A and 13B show examples of the printing menu screen displayed on the display section 55. FIG. 13A is a diagram illustrating an example of the printing menu screen for a horizontally shot image and FIG. 13B is a diagram illustrating an example of the printing menu screen for a vertically shot image.

The printing menu includes a reduced image of the selected shot image, a pull-down menu 59 for selecting the number of sheets to be printed, a pull-down menu 60 for selecting print characters, a character input screen selection icon 61, a printing execution icon 62, and a cancellation icon 63. The reduced image of the shot image is displayed after the posture of the reduced image is restored to the same image taken upon shooting based on the posture determination signal 70. When the photographer selects one of the icons from the printing menu screen by operating the cross operation key 38, the microcomputer 3 executes processing pertinent to the printing menu in accordance with the selected icon (Step 5).

In the pull-down menu 59 for selecting the number of sheets to be printed, the number of sheets to be printed can be specified by the photographer or the like. When the pull-down menu 59 for selecting the number of sheets to be printed is selected, the number of sheets to be printed is displayed as a pull-down menu on a part of the printing menu screen. The photographer or the like can select a desired number of sheets to be printed on the displayed pull-down menu by operating the cross operation key 38. When the microcomputer 3 determines that the number of sheets to be printed selected, the microcomputer 3 closes the pull-down menu and displays the selected number of sheets to be printed on the pull-down menu 59 for selecting the number of sheets (Step 6).

The pull-down menu 60 for selecting print characters is a printing menu with which the photographer or the like can select print characters to be printed together with a shot image and which corresponds to a character information adding section. When the pull-down menu 60 for selecting print characters is selected, similarly to the pull-down menu 59 for selecting the number of sheets to be printed, several kinds of phrases containing print characters, which have been previously stored in the print character memory 80, are displayed as a pull-down menu. The print character memory 80 is a read-only memory, having stored therein, for example, a plurality of character strings such as “HELLO! ” and “HOW ARE YOU!” When the microcomputer 3 recognizes that the print characters are selected, the microcomputer 3 closes the pull-down menu and the selected print characters are displayed on the pull-down menu 60 for selecting print characters (Step 7). For example, FIG. 13A is a diagram illustrating an example of a display, arranged on the display section, in which one is selected as the number of sheets to be printed and “HELLO!” is selected as the print characters.

The character input screen selection icon 61 is a printing menu with which the photographer or the like proceeds to a screen for inputting the print characters and which corresponds to a character information adding section. When the microcomputer 3 determines that the character input screen selection icon 61 is selected (Step 8), the microcomputer 3 displays a character input screen, used for inputting characters, on the printing menu screen on the display section 55. Thereafter, completion of inputting the characters is recognized and the printing menu is displayed again on the display section 55 (Step 9).

The cancellation icon 63 is a printing menu for canceling the printing processing. When the cancellation icon 63 is selected, the printing mode is canceled and the menu screen is displayed again on the display section 55 (Step 10).

The printing execution icon 62 is a printing menu for causing the external printing device 74 to execute printing based on a specified number of sheets to be printed, specified print characters and the like. When the printing execution icon 62 is selected (Step 11), the microcomputer 3 performs the printing processing (Step 12).

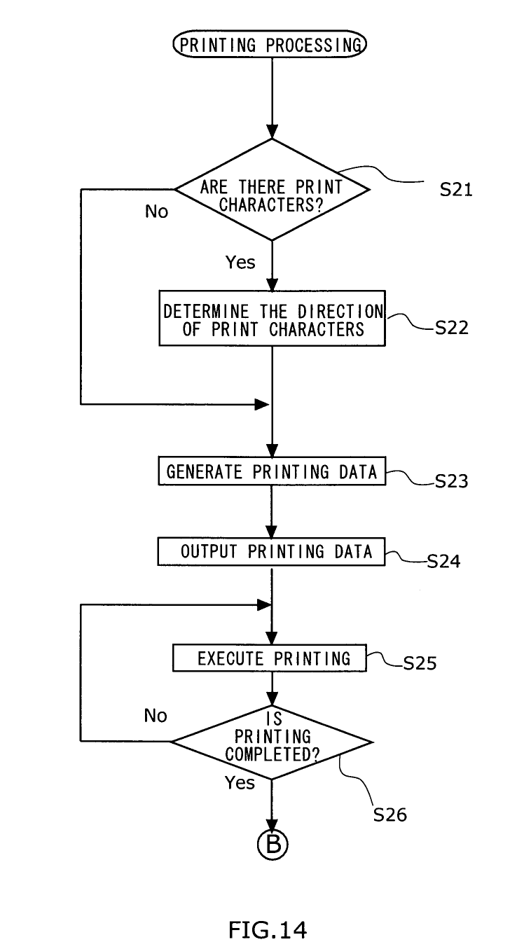

FIG. 14 shows a flowchart of printing processing of a shot image. When the printing execution icon 62 is selected, the microcomputer 3 determines presence or absence of print characters inputted or selected. When the print characters are contained, the microcomputer 3 causes the printing processing to proceed to the next step. On the other hand, when the print characters are not contained, the microcomputer 3 causes the printing processing to a step of generating printing data (Step 21). When the print characters are contained, the microcomputer 3 determines alignment of the print characters based on the posture determination signal 70. Data pertinent to the determined alignment is sent to the image printing control section 71 (Step 22). The image printing control section 71 generates printing data containing a synthesized image of a shot image and the print characters, the alignment of the print characters to be arranged, and the number of sheets to be printed (Step 23). The generated printing data is outputted by the printing data output section 72 (Step 24). The printing device 74 prints the synthesized image based on a printing instruction from the microcomputer 3 and the printing data (Step 25). Subsequently, the printing device 74 executes printing the selected number of sheets. On the other hand, the microcomputer 3 confirms that printing of the given number of sheets has been completed and displays the menu screen again on the display section 55.

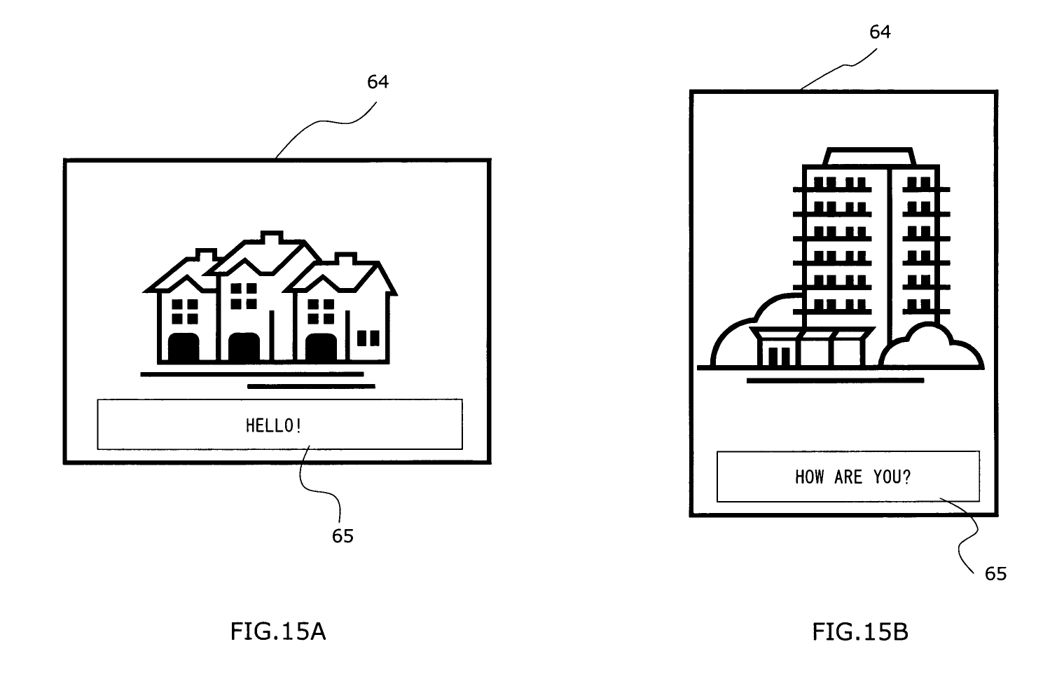

FIGS. 15A and 15B show examples of the synthesized image printed by the printing device 74. FIG. 15A is a diagram illustrating a print example of a horizontally shot image. FIG. 15B is a diagram illustrating a print example of a vertically shot image. As mentioned above, based on the posture determination signal 70, the image printing control section 71 generates the printing data of the synthesized image in which print characters are aligned so as to correspond to the direction of the shot image. Accordingly, as shown in FIGS. 15A and 15B, since the alignment of the print characters corresponds to the direction of the shot image, printing of a synthesized image having fine visibility is enabled. Thus, the photographer or the like is not required to perform an operation of matching the direction of the shot image and the direction of the print characters with each other by rotating the shot image or the print characters.

The image display control section 13 generates display data to be displayed on the display section 55 in accordance with the synthesized image outputted from the printing data output section 72. Thus, the photographer or the like is not required to perform an operation of matching the direction of the shot image and the direction of the print characters with each other by rotating the shot image or the print characters. In addition, the photographer or the like can make confirmation of the synthesized image to be printed by displaying the synthesized image on the display section. The synthesized image may be displayed on the display section prior to executing the printing.

As described above, according to the digital camera of the embodiment 1, the shooting posture of the digital camera 1 is detected by the image blur compensation mechanism and the posture determination signal corresponding to the posture is recorded together with the shot image. Accordingly, the digital camera according to the embodiment 1 is capable of determining the shooting posture without adding any new component.

Moreover, based on the posture determination signal, the image printing control section generates the printing data of the synthesized image in which the print characters are aligned so as to correspond to the direction of the shot image. Thus, based on the generated printing data, the external printing device is capable of printing the synthesized image, having fine visibility, in which the direction of the print characters and the direction of the shot image match with each other. Therefore, since the photographer or the like does not need to perform an operation of rotating the shot image or the print characters, the imaging device having high usability can be provided.

Furthermore, since the synthesized image in which the direction of the print characters and the direction of the shot image match with each other is displayed on the display section, visibility can be improved. Therefore, since the photographer or the like does not need to perform an operation of rotating the shot image or the print characters and can easily make confirmation of the synthesized image to be printed, the imaging device having high usability can be provided.

Although in the present embodiment, the print characters to be printed together with the shot image are selected or inputted upon the printing processing, the present invention is not limited thereto. For example, the data of the print characters may be stored in a header or footer of the image file containing the shot image.

### Embodiment 2

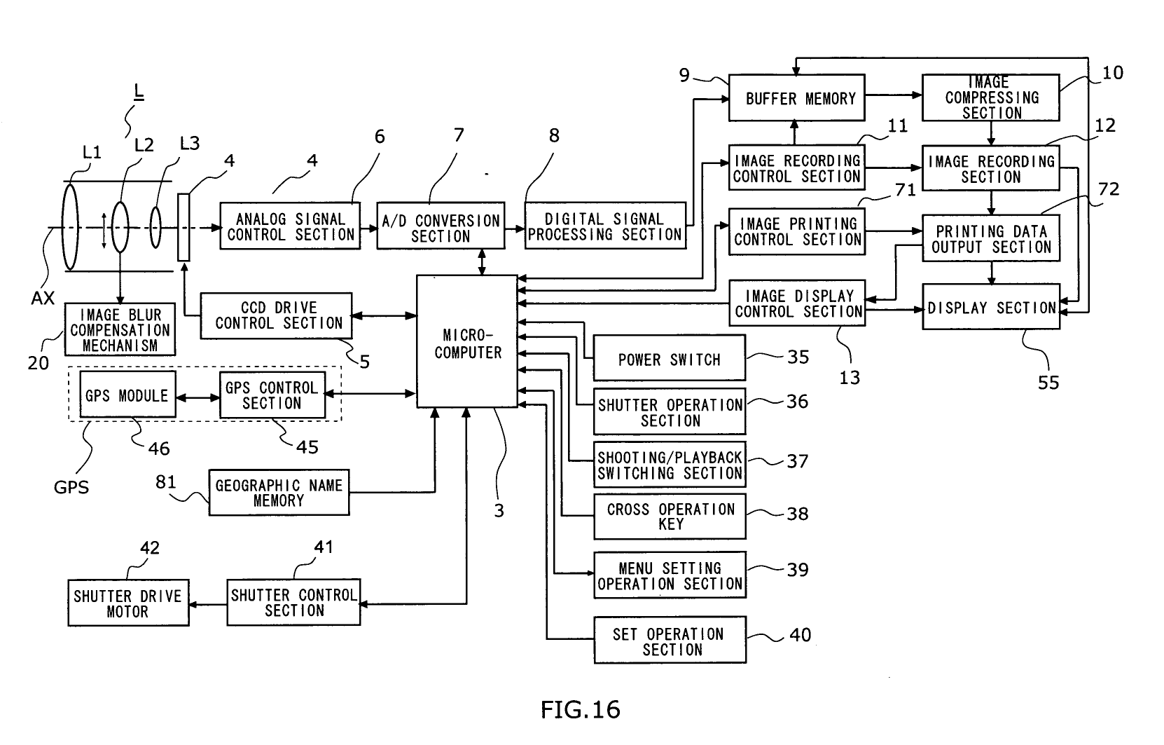

FIG. 16 is a schematic block diagram illustrating a configuration of a digital camera 200 according to an embodiment 2. Although the digital camera 200 has the substantially same configuration as that of the digital camera 1 according to the embodiment 1, the digital camera 200 is different from the digital camera 1 in that the digital camera 200 includes a GPS (Global Positioning System). The GPS includes a GPS control section 45 and a GPS module 46 and is capable of locating a position on the ground by using signals from satellites. By using the GPS, an image having synthesized from a shot image and positional information obtained by the GPS can be displayed or printed.

The GPS module 46, responding to an instruction signal from the GPS control section 45, receives signals from the satellites by a GPS antenna, which is not shown in the figures, and demodulates and decodes the received signals. Based on the demodulated signals, the positional information containing a longitude/latitude and an altitude is calculated. In a geographic name data memory 81, geographic name data in which names of specific locations such as prefectures and cities respectively correspond to longitudes and latitudes is stored.

After a shot image has been stored, a microcomputer 3 sends an instruction to the GPS control section 45 in order to obtain positional information corresponding to the shot image. The GPS control section 45 which has received the instruction operates the GPS module 46 and obtains the positional information. The obtained positional information is sent to the microcomputer 3. Based on the positional information sent from the GPS module 46 and the geographic name data stored in the geographic name data memory 81, the microcomputer 3 extracts geographic name and stores the extracted name in an image file. If the corresponding geographic name is not extracted, a latitude/longitude may be recorded as the positional information.

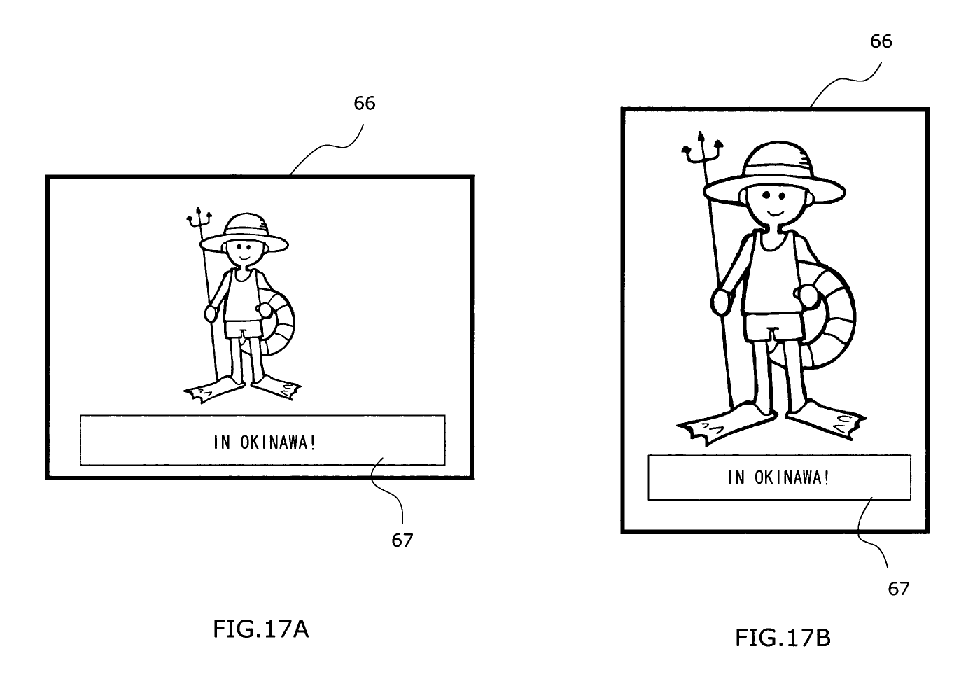

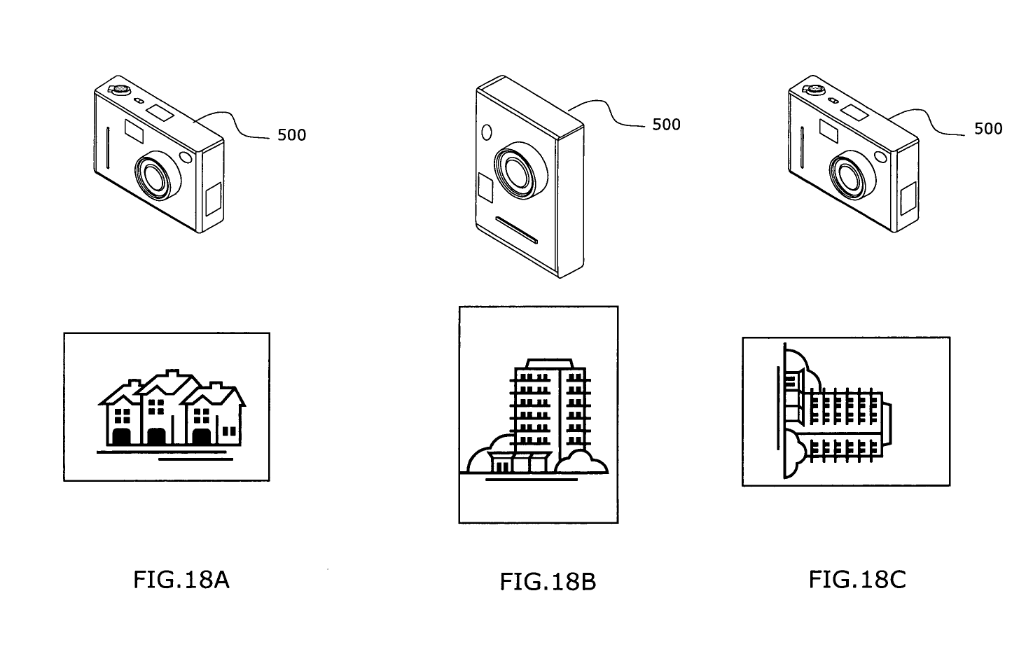

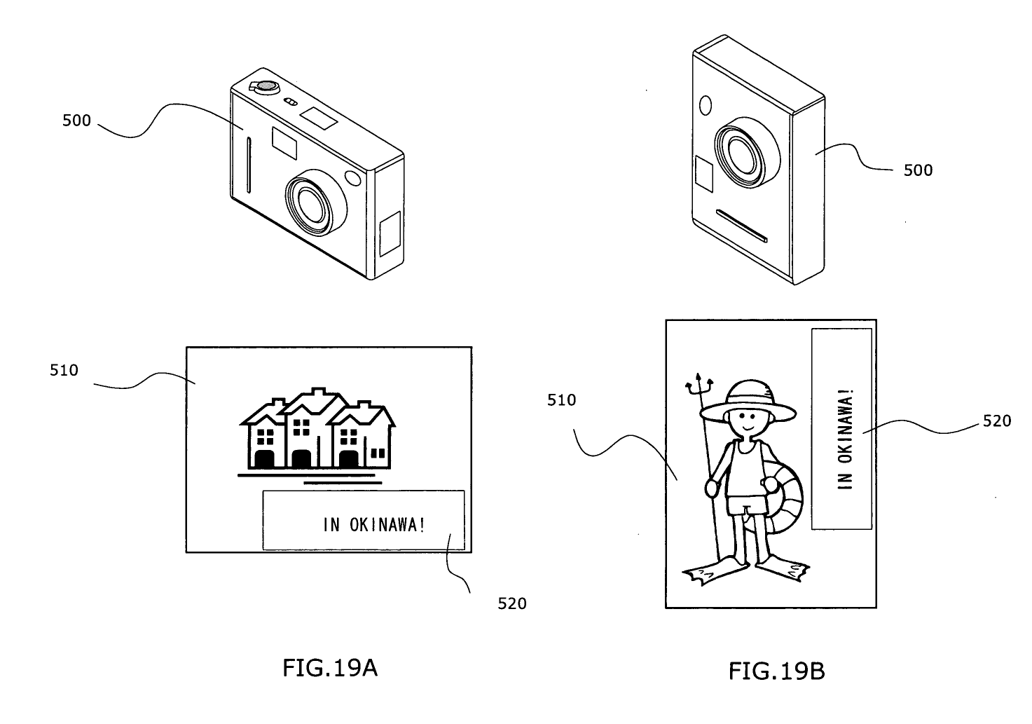

FIGS. 17A and 17B show synthesized images printed by a printing device 74. Although printing processing in the present embodiment is performed in a manner substantially similar to that in the embodiment 1, the printing processing in the present embodiment is different from that in the embodiment 1 in that the geographic name or the latitude/longitude is printed instead of the print characters selected or inputted by the pull-down menu 60 for selecting print characters. Thereupon, similarly to the embodiment 1, an image printing control section 71 generates printing data of a synthesized image in which information indicating the geographic name and/or the latitude/longitude is arranged so as to correspond to the direction of the shot image in accordance with the posture determination signal 70.

The image shot by the digital camera 200 is recorded in a data section of the image file. Thereupon, for example, in a case where the image is shot in Okinawa, recorded in a header portion or footer section of the image file is the geographic name of Okinawa, which is retrieved based on the latitude/longitude obtained by the GPS module 46. And in the printing processing, the image printing control section 71 arranges the print characters (“IN OKINAWA”) on the shot image based on the posture determination signal 70 such that the alignment of the print characters correspond to the direction of the shot image. The image printing control section 71 generates printing data pertinent to the synthesized image of the shot image and the print characters. Thus, the printing device is capable of printing the synthesized image having fine visibility. Therefore, a photographer or the like does not need to perform an operation of rotating the shot image and the print characters of the geographic name.

As described above, the digital camera according to the embodiment 2 can not only obtain the same effects as those attained by the embodiment 1 but also print the information of the shooting location together with the shot image. Thus, an imaging device which realizes fine visibility to the photographer or the like and has high added value can be provided.

Although in the present embodiment, the digital camera obtains the data of the shooting location based on the latitude/longitude obtained by the GPS and the previously stored geographic name data, the present invention is not limited thereto. For example, the digital camera may include an FM receiving section and may use geographic name data obtained by FM airwaves and the latitude/longitude obtained by the GPS.

Although in the present embodiment, instead of the characters selected or inputted by the photographer or the like, the positional information pertinent to the geographic names and/or the latitude/longitude is used as the print characters, the present invention is not limited thereto. A synthesized image may be obtained by arranging both of the selected or inputted characters and the positional information in the shot image.

Although in the embodiments 1 and 2, the image printing control section for generating the printing data is included in the digital camera, the present invention is not limited thereto. The image printing control section may be included in, for example, the printing device. Thus, based on the posture determination signal which is recorded together with the shot image in the image file, the printing device is capable of printing a synthesized image having fine visibility. The printing device may have a display section provided therein. By providing the display section, a printing menu can be displayed.

Although in the embodiments 1 and 2, the shot image and the print characters can be displayed on the display section of the digital camera, the present invention is not limited thereto. The shot image and the print characters may be displayed on an external monitor connected with the digital camera or on a printing device having a display section.

Although in the embodiments 1 and 2, the print characters are arranged in a lower portion of the shot image, the present invention is not limited thereto. For example, the print characters may be arranged in an upper portion or a middle portion of the shot image.

In the embodiments 1 and 2, templates such as calendars may be previously stored in the digital camera. Printing data of a synthesized image having one of the templates and a shot image may be outputted. Thus, since the photographer or the like does not need to rotate the shot image, an imaging device having high usability can be provided.

In the embodiments 1 and 2, when detection of the posture of the digital camera is performed by using the image blur compensation mechanism, there may be a case where the current supplied to the coil in the yawing direction is equal to the current supplied to the coil in the pitching direction, depending on the posture of the digital camera. Such a case is, for example, a case where a photographer shoots an image in a posture in which an optical axis direction of the digital camera and a direction of gravitational force are in parallel with each other, or a case where a photographer shoots an image in a posture in which the optical axis direction of the digital camera is perpendicular to the direction of gravitational force and in which the digital camera is rotated by a predetermined angle. In a case where the posture detection is not performed by the image blur compensation device, it may be determined that an image is shot in the horizontal shooting posture and a posture detection signal 0 may be added in the shot image. Alternatively, based on a photographer's setting, it may be determined that an image is shot in the vertical shooting posture and a posture detection signal 1 may be added in the shot image.

Although in the embodiments 1 and 2, determination of a shooting posture is performed by detecting both current values of the pitching current value detection section and the yawing current value detection section, the determination of the shooting posture may be performed by detecting at least one of the current values. Even if either one of the pitching current value detection section and the yawing current value detection section is abnormal, detecting both the current values, as described in the above embodiments, allows more accurate determination of the shooting posture.

Although in the embodiments 1 and 2, the determination of the shooting posture is performed by detecting both the current values of the pitching current value detection section and the yawing current value detection section, the present invention is not limited thereto. For example, by measuring voltage values, similar effect can be obtained.

Although in the embodiments 1 and 2, the example in which the USB cable is used as the cable via which the digital camera and the printing device are connected is described, the present invention is not limited thereto. For example, the digital camera and the printing device may be connected via an IEEE1394 serial bus cable or may be wirelessly connected by using a wireless LAN or the like

Although in the embodiments 1 and 2, the digital camera and the printing device are connected via the cable, the present invention is not limited thereto. For example, the printing data in the embodiments 1 and 2 may be recorded in a removable memory. And a printing device into which the removable memory can be inserted may perform printing.

Although in the embodiments 1 and 2, the digital camera including one shutter operation section is used, the present invention is not limited thereto. For example, a shutter operation section for shooting in a horizontal shooting posture and a shutter operation section for shooting in a vertical shooting posture are respectively mounted in a separate manner. By using the shutter operation sections, determination of a shooting posture may be performed.

Although in the embodiments 1 and 2, an angle of the horizontal shooting posture is 0 degree and the vertical shooting posture is obtained by the rotation by 90 degrees around the optical axis, the similar effect can be obtained by rotation by −90 degrees. A signal for detecting the posture obtained by the rotation by −90 degrees may be specified as a posture determination signal (2) and a total of three kinds of postures, including one kind of the horizontal shooting posture and two kinds of the vertical shooting posture, may be detected.

Although in the embodiments 1 and 2, the method in which the posture determination signal 70 (0) or the posture determination signal 70 (1) are added is used, the present invention is not limited thereto. Further, the present invention is not limited to the method in which the posture determination signals or the print characters are recorded in a shot image. The posture determination signals or the print characters may be recorded in a file different from that containing a shot image, and the shot image and the file having recorded therein the posture determination signals or the print characters may be associated with each other.

Although in the embodiments 1 and 2, the example in which the image blur compensation mechanism is used as posture detection means is described, the present invention is not limited thereto. For example, a posture may be detected by an angular sensor, a rotation detection device or the like, which is installed in the digital camera.

Although in the embodiments 1 and 2, the printing device is not included in the digital camera, the present invention is not limited thereto. The printing device may be included in the digital camera in an integrated manner. Even in such a case, the similar effect can be obtained.

Arbitrary combination of the components included in the printing system according to the embodiments 1 and 2 is possible. For example, the system may include a plurality of physically separated devices, such as the imaging optical system, the shooting unit, and the posture detection unit. The present invention is not limited to this combination of the components.

Although in the embodiments 1 and 2, the example in which the digital camera includes the recording medium for recording a shot image is described, the present invention is not limited thereto. For example, a cradle which includes a hard disk, needs no cable for connecting with the digital camera, and is capable of recording or accumulating shot images may be used. As a device for controlling the printing device, for example, a data storage which includes a hard disk or the like capable of storing a large number of shot images and has no imaging optical system may be used. If the data storage includes a display section and an image printing control section, the storage can be used in a manner similar to the digital camera.

### INDUSTRIAL APPLICABILITY

The imaging device and the printing device according to the present invention are applicable to a digital still camera and a digital video camera, a mobile phone and a PDA having a camera function, etc., in which comfortable printing display for printing shot images has been desired.

1. An imaging device which is operable to output an optical image of an object as an electrical image signal and to transmit the image signal to a connected printing device, comprising:
an imaging optical system for forming the optical image of the object;
an image sensor for receiving the optical image formed by the imaging optical system and converting the optical image to the electrical image signal;
a posture detection section for detecting a posture of the imaging device, which is taken upon shooting;
a recording section for recording a shot image represented by the image signal and posture information, which corresponds to the shot image and indicates the posture of the imaging device;
an adding section for adding character information, which corresponds to the shot image and contains a character string;
a printing control section for generating printing data containing the shot image and the character information; and
a printing data output section for outputting the generated printing data, wherein
the printing control section, based on the posture information, generates printing data containing the shot image and the character information which is added by the adding section so as to correspond to the direction of the shot image.

2. The imaging device according to claim 1, further comprising:
a display section for displaying the shot image and the character information; and
a display control section for restoring, based on the posture information, the direction of the shot image from the posture of the imaging device, which is taken upon shooting and for displaying the shot image having the restored posture and the character information added by the adding section so as to correspond to the direction of the shot image.

3. The imaging device according to claim 1, further comprising:
a receiving section for receiving an external signal; and
a position acquisition section for acquiring, based on the received signal, shooting positional information containing a latitude and a longitude.

4. The imaging device according to claim 3, further comprising:
a geographic name data storage section for storing data pertinent to a geographic name and data pertinent to a latitude and a longitude of the geographic name; and
a geographic name data extraction section for extracting a geographic name corresponding to the shooting position from the geographic name data storage section, wherein
the shooting positional information contained in the character information includes data pertinent to the geographic name extracted by the geographic name data extraction section.

5. The imaging device according to claim 1, further comprising an image blur compensation device for detecting vibration applied to the imaging device and driving a compensation lens in the shooting optical system in two directions perpendicular to an optical axis, wherein
the posture detection section determines a posture of the imaging device by detecting a signal for driving the compensation lens.

6. The imaging device according to claim 5, wherein
the image blur compensation device includes a first actuator and a second actuator for driving the compensation lens in the two directions perpendicular to the optical axis, and
the posture detection section determines a posture of the imaging device by detecting at least one of a driving current of the first actuator and a driving current of the second actuator.

7-11. (canceled)

12. A printing system including an imaging device and a printing device, which are connectable, wherein
the imaging device comprises:
a recording section for recording an image file containing a shot image and posture information, which corresponds to the shot image and indicates a posture of the imaging device;
an adding section for adding character information, which corresponds to the shot image and contains a character string, to the image file;
the printing device comprises:
a printing control section for generating printing data containing the shot image and the character information added so as to correspond to the direction of the shot image, based on the image file containing the added character information; and
a printing section for printing the shot image and the character information based on the printing data.

13. The printing device comprising:
a printing control section for generating printing data containing an shot image and character information added so as to correspond to the direction of the hot image, based on an image file containing the shot image, posture information which corresponds to the shot image and indicates a posture of the imaging device, and character information which contains a character string; and
a printing section for printing the shot image and the character information based on the printing data.
